(19) United States
(12) Patent Application Publication
(10) Pub. No.: US 2026/0336568 A1
(43) Pub. Date: Oct. 29, 2026

(54) POLYMERIC PANEL WITH INTEGRAL FLUID CHANNELS

(71) Applicant: GM Global Technology Operations LLC, Detroit, MI (US)

(72) Inventors: Thomas W. Jozwiak, Southgate, MI (US); Lane G. Lindstrom, Oxford, MI (US); Thomas Alexander Jozwiak, Southgate, MI (US)

(21) Appl. No.: 19/191,546

(22) Filed: Apr. 28, 2025

(51) Int. Cl. B60S 1/50; B29C 49/06; B29C 49/42; B29L 31/30; B60S 1/52

(52) U.S. Cl. CPC B60S 1/50; B29C 49/0665; B29C 49/42815; B60S 1/52; B29L 2031/3032; B29L 2031/3041

(57) ABSTRACT

A polymeric panel includes a panel body of a thermoplastic material. A fluid channel is formed during an injection molding stage of the thermoplastic material of the panel body. The fluid channel defines a hollow tubular shape for flow of a fluid within the fluid channel. A connector of the thermoplastic material integrally is fixed to a free end of the fluid channel and is adapted to connect to a fluid source S including a fluid reservoir.

### INTRODUCTION

The present disclosure relates to injection molded vehicle panels with fluid transfer.

During vehicle operation, fluids including washer fluid, water and air may be delivered to vehicle features including windshields, rear windows, headlamps, and air dams to clean or de-ice surfaces of the vehicle features. Delivery of these fluids is commonly provided from a fluid reservoir via tubing which is connected to vehicle panels and molded panels, requiring tubing installation, connection brackets and clamps, tubing hangers, and molded panel connection features.

While current systems and methods to provide fluid for vehicle cleaning and de-icing purposes achieve their intended purpose, there is a need for a new and improved system and method for transferring fluid via a polymeric vehicle panel.

### SUMMARY

According to several aspects, a polymeric panel includes a panel body of a thermoplastic material. A fluid channel is formed during injection molding of the thermoplastic material of the panel body. The fluid channel defines a hollow tubular shape for flow of a fluid within the fluid channel. A connector of the thermoplastic material is integrally fixed to a free end of the fluid channel and is adapted to connect to a fluid source S including a fluid reservoir.

In another aspect of the present disclosure, a nozzle attachment cavity is formed in the panel body. A nozzle is releasably fixed into the nozzle attachment cavity having the fluid channel directed toward the nozzle attachment cavity. A fluid header directs flow of a fluid out of the fluid channel into the nozzle fixed in the nozzle attachment cavity.

In another aspect of the present disclosure, an elastomeric seal member defining an O-ring is provided with the nozzle elastically engaging an inner wall of the nozzle attachment cavity to provide a fluid seal of the nozzle within the nozzle attachment cavity.

In another aspect of the present disclosure, the panel body includes an exit-entry port co-molded with the panel body.

In another aspect of the present disclosure, the exit-entry port of the panel body is integrally connected to and extends outwardly from a surface of the panel body, the exit-entry port being in communication with the fluid channel and serving during operation of the panel body as a fluid discharge port to discharge a fluid passing through the fluid channel.

In another aspect of the present disclosure, the panel body includes at least one connection member including a mounting flange for attachment of the panel body to a vehicle.

In another aspect of the present disclosure, the panel body defines an air inlet panel connected to a vehicle.

In another aspect of the present disclosure, a connector is integrally fixed to a free end of the fluid channel.

In another aspect of the present disclosure, the fluid channel includes at least one of: a straight section; a bend; and a raised portion of the panel body.

In another aspect of the present disclosure, an inner diameter D of the fluid channel ranges from approximately 3.0. mm to approximately 3.6 mm. A shape of the fluid channel is not limited to a circular shape and may be larger or smaller than 3.0 mm to 3.6 mm.

According to several aspects, a vehicle polymeric panel comprises a panel body of an injection molded thermoplastic material. A first fluid channel extends at least partially through the thermoplastic material during injection molding of the panel body. The first fluid channel defines a hollow tubular shape for flow of a fluid within the first fluid channel. A connector of the thermoplastic material is integrally fixed to a free end of the first fluid channel and adapted to connect to a fluid source S including a fluid reservoir. An exit port of the thermoplastic material is integrally fixed to a second free end of the first fluid channel and adapted to discharge the fluid out of the first fluid channel.

In another aspect of the present disclosure, a second panel body of the injection molded thermoplastic material is provided. At least a second fluid channel extends at least partially through the thermoplastic material during injection molding of the second panel body, the second fluid channel defining a hollow tubular shape providing a flow of the fluid within the second fluid channel.

In another aspect of the present disclosure, the second panel body is sealingly engaged with the connector of the first panel body, with the first fluid channel of the first panel body in communication with the second fluid channel of the second panel body.

In another aspect of the present disclosure, the first panel body defines an air inlet panel connected to a vehicle.

In another aspect of the present disclosure, the first panel body defines a headlight fluid distribution panel connected to a vehicle.

In another aspect of the present disclosure, the first panel body defines a vehicle rear fluid distribution panel connected to a vehicle.

In another aspect of the present disclosure, the first panel body defines one of: a light detection and ranging (lidar) sensor mount connected to a vehicle; and a camera housing connected to the vehicle.

According to several aspects, a method employing a gas injection molding process for forming a polymeric panel comprises: engaging a first mold section with a second mold section of a mold having a mold cavity enclosed by the first mold section and the second mold section; filling the mold cavity with a polymer melt of a thermoplastic material; aligning a gas injector and an exit passage with the mold cavity, with the exit path initially closed to prevent discharge of the polymer melt; injecting a pressurized gas into the gas injector and into the polymer melt to initiate formation of a hollow passage within the polymer melt by displacing a first portion of the polymer melt while maintaining the exit passage closed; and maintaining flow of the gas and opening the exit passage allowing a second portion of the polymer melt to outwardly displace via the exit passage to create a continuous, hollow flow channel extending from the gas injector to the exit passage.

In another aspect of the present disclosure, the method further includes discharging the second portion of the polymer melt out of the exit passage into a well located outside of the mold.

In another aspect of the present disclosure, the method further includes: forming a nozzle attachment cavity having the flow channel in a panel body during formation of the panel body; and releasably fixing a nozzle into the nozzle attachment cavity having the fluid channel oriented toward the nozzle attachment cavity to direct a fluid flow out of the fluid channel into the nozzle fixed in the nozzle attachment cavity.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a top plan view of an air inlet panel having a system of fluid channels according to an exemplary aspect;

FIG. 2 is a cross-sectional side elevational view of a mold cavity filled with a polymer melt prior to a gas injection stage;

FIG. 3 is a cross-sectional side elevational view similar to FIG. 2 during an initial portion of the gas injection stage;

FIG. 4 is a cross-sectional side elevational view modified from FIG. 3 after completion of the gas injection stage;

FIG. 5 is a partial cross-sectional side elevational view modified from FIG. 1 to include a spray fitting inserted into the air inlet panel;

FIG. 6 is a partial cross sectional side elevational view reversed from FIG. 5;

FIG. 7 is an end elevational view of the air inlet panel of FIG. 1;

FIG. 8 is an end elevational view of area 8 of FIG. 7;

FIG. 9 is a front left perspective view of a vehicle having the vehicle panel with integral fluid channels of the present disclosure; and

FIG. 10 is a top plan view of a second panel body sealingly engaged with the panel body of FIG. 1.

### DETAILED DESCRIPTION

The following description is merely exemplary in nature and is not intended to limit the present disclosure, application, or uses.

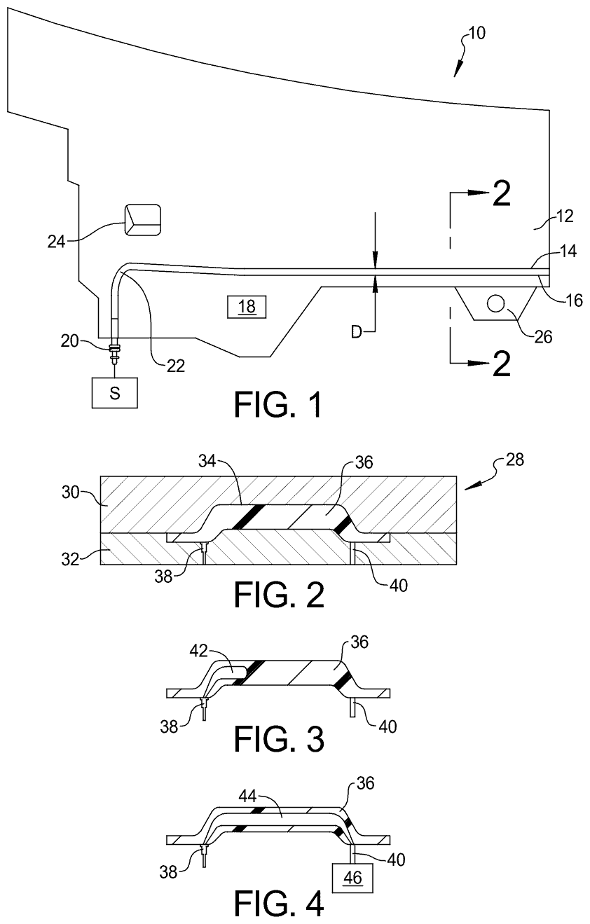

Referring to FIG. 1, a vehicle panel with integral fluid channels 10 includes a polymeric material panel body 12 may be formed or molded using an injection molding process and including a thermoplastic material adapted for injection molding. At least one fluid channel 14 is formed during an injection molding stage of the panel body 12 as described below in reference to FIGS. 2 through 4. The fluid channel 14 defines a hollow tubular shape sized to allow flow of a fluid such as a window washing fluid, air, water and the like. According to several aspects, an inner diameter D of the fluid channel 14 may range from approximately 3.0. mm to approximately 3.6 mm which may vary depending on a type of fluid delivered by the fluid channel 14 and a volumetric flow rate desired, for example to avoid fluid freeze during cold weather operation. The inner diameter D of the fluid channel 14 is also not uniformly round in shape, but may vary in shape with channel length, material thickness and the like. Fluid channels used for air transfer may for example be up to approximately 15 mm diameter. The fluid channel 14 includes one or more straight sections, one or more bends or elbows, and may define a raised portion of the panel body including a panel section 18. According to several aspects, a connector 20 is integrally fixed, such as during the molding process to and thereby defining a first free end of the fluid channel 14, and is adapted to connect to a fluid source S such as fluid reservoir. As noted in reference to FIG. 3, the connector 20 also provides an inlet for gas injection during a gas injection molding process. Incorporation of the fluid channel 14 into the panel body 12 obviates a requirement for external tubing and tubing attachment hardware to permit fluid transfer. At least one bend 22 may be included with the fluid channel 14 to accommodate directional changes required for fluid transfer.

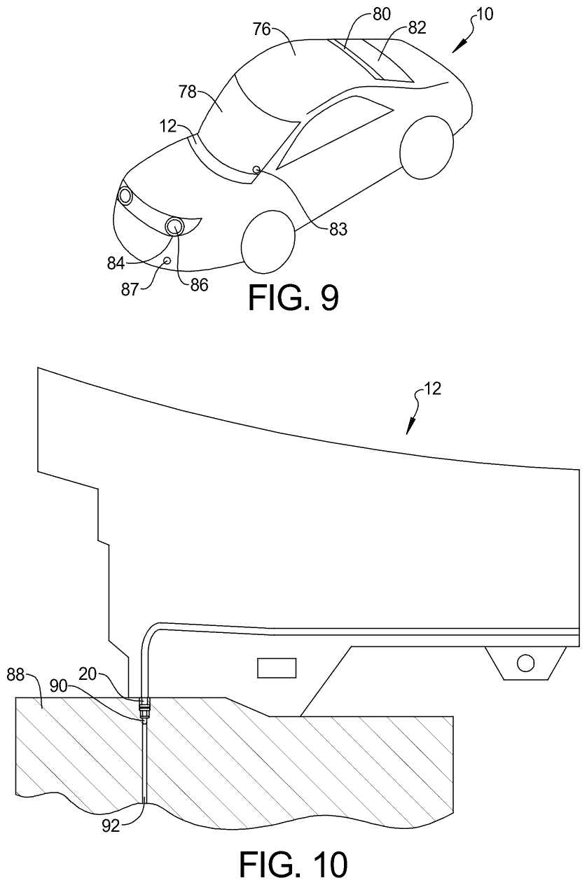

With continuing reference to FIG. 1, according to several aspects, the panel body 12 may define an air inlet panel used for a vehicle 76 shown and described in greater detail in reference to FIG. 9. As such, the panel body 12 may integrally include ducting 24 for example to allow air transfer into or out of a vehicle ventilation system. The panel body 12 also includes one or more connection members including a mounting flange 26 for attachment of the panel body 12 to the vehicle 76. According to several aspects, the ducting 24 and the mounting flange 26 are also formed during an injection molding stage of the panel body 12.

Referring to FIGS. 2 through 4 and again to FIG. 1, multiple injection molding steps are described for formation of the fluid channel 14. With specific reference to FIG. 2, a gas injection molding process is presented wherein a mold 28 having a first mold section 30 contacts a second mold section 32 and having a mold cavity 34 enclosed by the first mold section 30 and the second mold section 32. The mold cavity 34 is filled with a polymer melt 36 of a thermoplastic material. A gas injector 38 and an exit port 40 are aligned with mold cavity 34, having the exit port 40 initially closed to flow.

Referring to FIG. 3 and again to FIG. 2, a pressurized gas such as nitrogen gas or air is injected for example via a needle inserted into the gas injector 38 with the exit port 40 initially remaining closed. The gas is directed into the polymer melt 36 and initiates formation of a hollow passage 42 within the polymer melt 36 by displacing a first portion of the polymer melt 36.

Referring to FIG. 4 and again to FIGS. 2 and 3, flow of the gas is continued and the exit port 40 is opened allowing a second portion of the polymer melt 36 equivalent to a volume of displaced polymer melt 36 to outwardly displace via the exit port 40. Displacement of the second portion of the polymer melt 36 by the pressurized gas ultimately creates a continuous, hollow flow channel 44 extending from a location of the gas injector 38 to the exit port 40. The flow channel 44 may define for example the fluid channel 14 described above in reference to FIG. 1. In addition to the exit port 40 providing a discharge path for fluid passing through the fluid channel 14, the exit port 40 provides a discharge path during the injection molding process wherein the second portion of the polymer melt 36 displaced by the gas during formation of the flow channel 44 is discharged out of the exit port 40 into a well 46 which may be located outside of the mold 28.

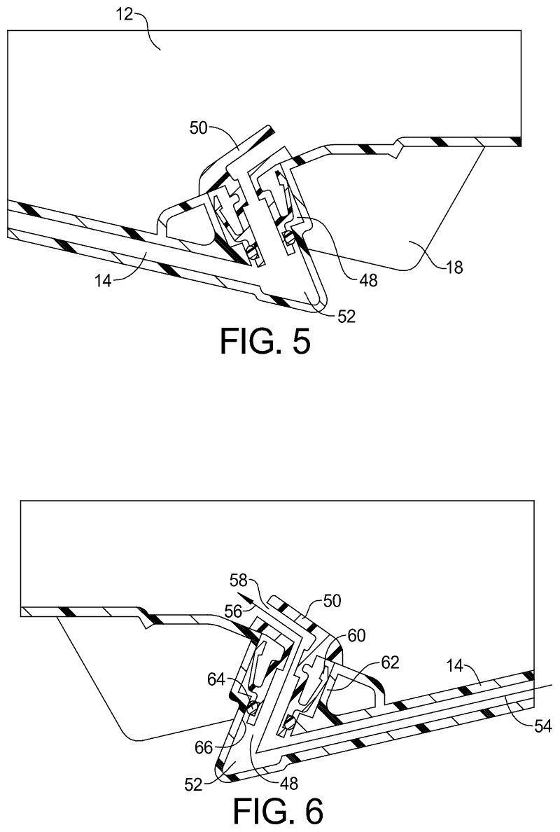

Referring to FIG. 5 and again to FIGS. 1 through 4, during formation of the panel body 12 including the fluid channel 14, a nozzle attachment cavity 48 may also be formed. A nozzle 50, for example a windshield washer nozzle, may be releasably fixed into the nozzle attachment cavity 48. The fluid channel 14 is directed toward the nozzle attachment cavity 48 and a fluid header 52 may be created to direct fluid flow out of the fluid channel 14 into the nozzle 50 seated in the nozzle attachment cavity 48.

Referring to FIG. 6, the fluid header 52 may include for example a gas blow hole which creates the fluid header 52 described in reference to FIG. 5. An exemplary fluid flow 54 via the fluid channel 14 may define a fluid including a window washing fluid, which enters the fluid header 52 and displaces as a spray pattern 56 out of a nozzle aperture 58 of the nozzle 50. A deflecting arm 60 may be provided on a body of the nozzle 50 which releasably engages with a shoulder 62 formed in the nozzle attachment cavity 48 during the injection molding operation to retain the nozzle 50. An elastomeric seal member 64 such as an O-ring may be provided with the nozzle 50 which engages an inner wall 66 of the nozzle attachment cavity 48 to provide a fluid seal of the nozzle 50 within the nozzle attachment cavity 48.

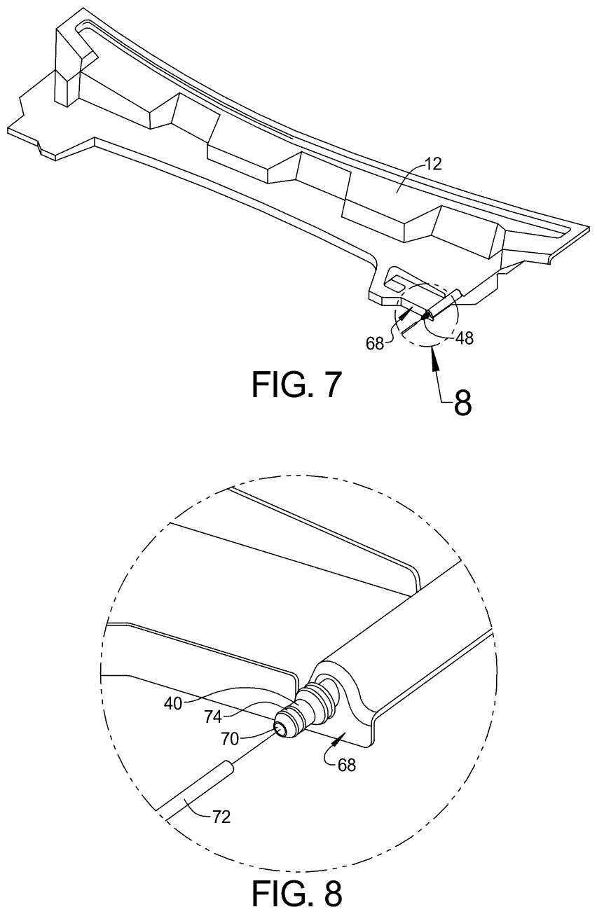

Referring to FIG. 7 and again to FIG. 1, the exit port 40 may also be co-molded and therefore formed together with the panel body 12 during the injection molding process. The exit port 40 is integrally fixed, such as during the molding process to and thereby defines a second free end of the fluid channel 14. According to several aspects, the exit port 40 is integrally connected to and extends outwardly from a surface 68 of the panel body 12. As noted above, the exit port 40 communicates with the fluid channel 14 and also serves during operation of the panel body 12 as a fluid discharge port such as to discharge windshield washer fluid passing through the fluid channel 14.

Referring to FIG. 8 and again to FIG. 7, the exit port 40 includes a hollow flow passage 70 from which may be used to discharge the pressurized gas used during injection molding, or to discharge a polymer melt 36 ejection flow 72. A seal member 74 may be attached on the exit port 40 to provide a fluid tight and pressure seal during use of the exit port 40, thereby also defining the exit port 40 as a hose quick connect feature.

Referring to FIG. 9 and again to FIGS. 1 through 8, the vehicle panel with integral fluid channels 10 may be incorporated in the vehicle 76 such as a sedan, a sport utility vehicle, a van, a truck, a battery electric vehicle, or the like. The panel body 12 may be positioned for use as an air inlet panel allowing the fluid channel 14 to pass washer fluid to a vehicle windshield 78. A similarly designed and injection molded vehicle rear fluid distribution panel 80 formed similar to the panel body 12 may also be positioned proximate a vehicle rear window 82 to pass washer fluid to the vehicle rear window 82. According to several aspects, the first panel body 12 may also include a vehicle mounted camera housing 83. A similarly designed and injection molded headlight fluid distribution panel 84 may be positioned proximate to a vehicle headlight 86 to allow cleaning of the vehicle headlight 86 using a fluid such as a washing fluid, water or air. According to several aspects, the first panel body 12 may also include a vehicle mounted light detection and ranging (lidar) sensor mount 87.

Referring to FIG. 10 and again to FIG. 1, a second panel body 88, as well as additional panel bodies not shown are also formed using the gas injection molding process and a thermoplastic material. The second panel body 88 may be adapted to connect to the first panel body 12, having the connector 20 of the first panel body 12 sealingly received in a receiving port 90 formed within the second panel body 88. The second panel body 88 includes a second fluid channel 92 formed similarly to the first fluid channel 14, with the second fluid channel 92 in fluid communication with the first fluid channel 14 upon receipt of the connector 20 within the receiving port 90.

The vehicle panel with integral fluid channels 10 of the present disclosure negates the need to add a washer hose assembly to an air inlet panel for washer fluid transfer. Fluid channels are created with a gas assisted injection molding process commonly used to improve mold packing, dimensional stability, and the light weighting of a molded part. According to several aspects, the vehicle panel with integral fluid channels 10 of the present disclosure eliminates added content of a washer tube assembly from an air inlet panel by the creation of integral fluid channels within the panel.

The vehicle panel with integral fluid channels 10 of the present disclosure extends the use of a gas injection molding process to create a fluid delivery system for the transfer of liquid within a plastic panel. The process includes formation of in-molded channels utilizing the gas entry and exit points to form features for mating component connection during an injection molding process. Spray nozzle integration areas are formed to enable the nozzles to be snapped into location and serviced similar to conventional nozzles, while eliminating the need for an operator to connect the nozzles to a mating hose assembly. The main liquid fluid quick connect feature defining a fluid entry point also serves as either a gas entry or exit point and is formed during the injection molding process. Gas blow-out areas do not have to be well controlled as the sealing surfaces for the mating components are formed in the main injection process. As a result, mating surfaces are formed cleanly and dimensionally correct for the use of O-ring seals to create the seal between the plastic panel and mating components.

The vehicle panel with integral fluid channels 10 of the present disclosure integrates a hose quick connect feature with the gas injection point or gas exit. A nozzle interface to the panel for sealing defines an integral part of the design.

The vehicle panel with integral fluid channels 10 of the present disclosure maintains serviceability of the nozzles and transparency within the manufacturing process.

The vehicle panel with integral fluid channels 10 of the present disclosure be added to any plastic panel and is not limited to air inlet panels. The vehicle panel with integral fluid channels 10 of the present disclosure may be utilized in complex sensor washer systems utilized in air panels, fascia's, spoilers, camera mounts, light detection and ranging (lidar) sensor mounts, license plate appliques, headlamps for headlamp washing and the like. The vehicle panel with integral fluid channels 10 while disclosed herein for example having a substantially flat panel shape may have any geometric shape desired, including round, oval, square, rectangular, ovoid and the like.

A vehicle panel with integral fluid channels 10 of the present disclosure offers several advantages. These include: reduced engineered content and reduced assembly labor. Fluid channels may be formed on part edges to reduce the potential of visible read through on a class “A” or visible surface.

What is claimed is:

1. A polymeric panel, comprising:
a panel body of a thermoplastic material;
a fluid channel formed during injection molding of the thermoplastic material of the panel body, the fluid channel defining a hollow tubular shape for flow of a fluid within the fluid channel; and
a connector of the thermoplastic material integrally fixed to a free end of the fluid channel and adapted to connect to a fluid source S including a fluid reservoir.

2. The polymeric panel of claim 1, further including:
a nozzle attachment cavity formed in the panel body;
a nozzle releasably fixed into the nozzle attachment cavity having the fluid channel directed toward the nozzle attachment cavity; and
a fluid header directing flow of a fluid out of the fluid channel into the nozzle fixed in the nozzle attachment cavity.

3. The polymeric panel of claim 2, including an elastomeric seal member defining an O-ring provided with the nozzle elastically engaging an inner wall of the nozzle attachment cavity to provide a fluid seal of the nozzle within the nozzle attachment cavity.

4. The polymeric panel of claim 1, wherein the panel body includes an exit-entry port co-molded with the panel body.

5. The polymeric panel of claim 4, wherein the exit-entry port of the panel body is integrally connected to and extends outwardly from a surface of the panel body, the exit-entry port being in communication with the fluid channel and serving during operation of the panel body as a fluid discharge port to discharge a fluid passing through the fluid channel.

6. The polymeric panel of claim 1, wherein the panel body includes at least one connection member including a mounting flange for attachment of the panel body to a vehicle.

7. The polymeric panel of claim 1, wherein the panel body defines an air inlet panel connected to a vehicle.

8. The polymeric panel of claim 1, further including a connector integrally fixed to a free end of the fluid channel.

9. The polymeric panel of claim 1, wherein the fluid channel includes at least one of:
a straight section;
a bend; and
a raised portion of the panel body.

10. The polymeric panel of claim 1, wherein an inner diameter D of the fluid channel ranges from approximately 3.0. mm to approximately 3.6 mm.

11. A vehicle polymeric panel, comprising:
a first panel body of an injection molded thermoplastic material;
a first fluid channel extended at least partially through the thermoplastic material during injection molding of the first panel body, the first fluid channel defining a hollow tubular shape for flow of a fluid within the fluid channel;
a connector of the thermoplastic material integrally fixed to a first free end of the first fluid channel and adapted to connect to a fluid source S including a fluid reservoir; and
an exit port of the thermoplastic material integrally fixed to a second free end of the first fluid channel and adapted to discharge the fluid out of the first fluid channel.

12. The vehicle polymeric panel of claim 11, further including:
a second panel body of the injection molded thermoplastic material; and
at least a second fluid channel extended at least partially through the thermoplastic material during injection molding of the second panel body, the second fluid channel defining a hollow tubular shape providing a flow of the fluid within the second fluid channel.

13. The vehicle polymeric panel of claim 12, wherein the second panel body is sealingly engaged with the connector of the first panel body, with the first fluid channel of the first panel body in communication with the second fluid channel of the second panel body.

14. The vehicle polymeric panel of claim 11, wherein the first panel body defines an air inlet panel connected to a vehicle.

15. The vehicle polymeric panel of claim 11, wherein the first panel body defines a headlight fluid distribution panel connected to a vehicle.

16. The vehicle polymeric panel of claim 11, wherein the first panel body defines a vehicle rear fluid distribution panel connected to a vehicle.

17. The vehicle polymeric panel of claim 11, wherein the first panel body defines one of:
a light detection and ranging (lidar) sensor mount connected to a vehicle; and
a camera housing connected to the vehicle.

18. A method employing a gas injection molding process for forming a polymeric panel, comprising:
engaging a first mold section with a second mold section of a mold having a mold cavity enclosed by the first mold section and the second mold section;
filling the mold cavity with a polymer melt of a thermoplastic material;
aligning a gas injector and an exit passage with the mold cavity, with the exit passage initially closed to prevent discharge of the polymer melt;
injecting a pressurized gas into the gas injector and into the polymer melt to initiate formation of a hollow passage within the polymer melt by displacing a first portion of the polymer melt while maintaining the exit passage closed; and
maintaining flow of the gas and opening the exit passage allowing a second portion of the polymer melt to outwardly displace via the exit passage to create a continuous, hollow flow channel extending from the gas injector to the exit passage.

19. The method of claim 18, further including discharging the second portion of the polymer melt out of the exit passage into a well located outside of the mold.

20. The method of claim 18, further including:
forming a nozzle attachment cavity in a panel body having the flow channel during formation of the panel body; and
releasably fixing a nozzle into the nozzle attachment cavity having the fluid channel oriented toward the nozzle attachment cavity to direct a fluid flow out of the fluid channel into the nozzle fixed in the nozzle attachment cavity.
